(19) United States
(12) Patent Application Publication
(10) Pub. No.: US 2005/0123654 A1
(43) Pub. Date: Jun. 9, 2005

(54) Decorative containers including correspondingly scented or flavored contents and packages and displays including the containers

(76) Inventors: Paul J. Christensen, Salem, UT (US); Douglas P. Larsen, Orem, UT (US)

Correspondence Address: TRASK BRITT, P.O. BOX 2550, SALT LAKE CITY, UT, 84110, US

(21) Appl. No.: 10/728,378

(22) Filed: Dec. 3, 2003

(51) Int. Cl. A23G 1/00

(52) U.S. Cl. 426/104

(57) ABSTRACT

Decorative containers, such as tins, have a recognizable external appearance and are at least partially filled with contents that have flavors or fragrances, or scents, that correspond to the external appearances of the containers. The containers may appear as bakery goods, fruits, or other items. Various contents that may be stored or kept in such containers include, but are not limited to, candles, air fresheners, candies, creams, balms, waxes, gels, water-absorbent particles or beads, bath salt, and liquids. Methods of manufacturing and using the containers are also described.

### BACKGROUND OF THE INVENTION

1. Field of the Invention

The present invention relates to decorative containers, such as tins, with a recognizable external appearance and contents having flavors or fragrances, or scents, that correspond to the external appearances of the containers. More specifically, the present invention includes decorative containers, the exteriors of which may have the appearance of bakery goods and within which contents are stored which have scents or flavors that correspond to the external appearance of the containers.

2. Background of Related Art

It is well known that candles may have a variety of fragrances, which may be detected prior to lighting the candle, but which are released to a greater extent when the candle is lit.

The scents of various bakery goods, such as cookies, muffins, pies, doughnuts, cakes, breads, and the like, are replicated by some of many types of candle fragrances that are currently available. These scents are typically desirable to individuals who appreciate the smell of fresh-baked goods.

In addition to providing the scents of bakery goods, some scented candles have been developed which also provide the appearance of the bakery good represented by the fragrances thereof. Unfortunately, as these candles burn, the bakery good appearances thereof become distorted and may completely disappear, which may render them less desirable from a visual standpoint.

Containers for candles may be in the form of so-called “tins,” which are metal containers, or they may be formed from ceramic, glass, plastic, or a variety of other materials. Containers for other types of goods, such as air freshening compositions, creams and balms, candies, and the like are also well known in the art, and may be the same as or similar to containers for candles. The exteriors of such containers may have indicia formed thereon or have a decorative appearance.

The inventor is not aware of any decorative containers having the appearance of bakery goods, or of containers within which contents are stored which have scents or flavors that correspond to the external appearances of such containers.

### SUMMARY OF THE INVENTION

The present invention includes containers, such as tins, with a decorative external appearance. The contents of such containers may have flavors or fragrances, or scents, that correspond to the external appearance of the containers.

In one embodiment, a container according to the present invention includes a base with a receptacle therein and a cover configured to be assembled with the base so as to substantially enclose the receptacle. The cover may also be configured to be secured to the base when assembled therewith. Exterior surfaces of the cover and, optionally, the base may be configured with a desired appearance. The exterior surfaces may also carry indicia, such as paint, ink, decals, or the like, that enhance the external appearance of the container.

The receptacle of the base may be at least partially filled with one or more contents, such as a candle, an air freshening composition, or “air freshener,” pieces of candy, a volume of cream, balm, wax, gel, water-absorbent particles or beads, or liquid, bath salts, or the like. The contents of the receptacle may be scented or flavored in a manner that corresponds to the external appearance of the container.

As a specific example, a container may have the external appearance of a bakery good, such as a cookie, muffin, bagel, doughnut, pie, cake, or the like. The exterior surfaces of the cover of such a container may have the appearance of the top of such a bakery good. The exterior surfaces of the base of such a container may have the appearance of the bottom of the represented bakery good. Of course, containers with other (i.e., than bakery good) appearances are also within the scope of the present invention.

Continuing with the example of a container having the external appearance of a bakery good, the receptacle of the base thereof may be at least partially filled with a candle having a scent which approximates the scent of the represented bakery good. Alternatively, an air freshener, pieces of candy, a volume of cream, balm, wax, gel, water-absorbent particles or beads, or liquid, bath salts, or other contents having a scent or flavor that approximates the respective scent or flavor of the bakery good may be stored within the receptacle of the base. Optionally, the appearance of the contents of the receptacle may have an appearance similar to that of the exterior of the container.

In another aspect, the present invention includes packaging and displays for one or more containers according to the present invention. A package or display according to the present invention may have an appearance which resembles packaging or a display for the item represented by the external appearance of the container or containers. For example, if the container has the appearance of a cookie, a display may resemble a cookie package. As another example, if the container has the appearance of a doughnut, packaging or a display for the container may look like a doughnut box, and may be configured to receive a dozen containers. In still another example, if the container has the appearance of a pie, the package may resemble a pie box.

Other features and advantages of the present invention will become apparent to those of ordinary skill in the art through consideration of the ensuing description, the accompanying drawings, and the appended claims

### BRIEF DESCRIPTION OF THE DRAWINGS

In the drawings, which depict exemplary embodiments of various features of the present invention:

FIG. 1 is a perspective view of an exemplary container according to the present invention, showing a cover of the container assembled with a base of the container;

FIG. 2 is a perspective assembly view of the container shown in FIG. 1, illustrating the cover of the container disassembled from the base of the container and depicting a receptacle of the base;

FIG. 3 is a perspective assembly view of the container depicted in FIGS. 1 and 2, with a candle in the receptacle of the base thereof;

FIG. 3A is a perspective assembly view of the container depicted in FIGS. 1 and 2, with other types of contents in the receptacle of the base thereof;

FIG. 3B is a perspective assembly view of a container having the appearance of another item, with pieces of candy have a flavor which corresponds to the external appearance of the container in the receptacle of the base thereof;

FIG. 4 is a top view of the container shown in FIGS. 1 through 3;

FIG. 5 is a bottom view of the container illustrated in FIGS. 1 through 4;

FIG. 6 is a side assembly view of the container shown in FIGS. 1 through 5;

FIGS. 7 through 14 are perspective views of some other examples of containers that incorporate teachings of the present invention;

FIG. 15 is a perspective view of an example of a box within which a plurality of containers according to the present invention are stored;

FIG. 16 is a perspective view of another example of a box within which at least one container according to the present invention is stored or displayed;

FIG. 17 is a perspective view of a bakery shelf within which a plurality of containers according to the present invention are stored or displayed;

FIGS. 18 through 20 are perspective views of other apparatus for presenting containers that incorporate teachings of the present invention; and

FIG. 21 is a perspective view of another display apparatus for use with containers of the present invention.

### DETAILED DESCRIPTION

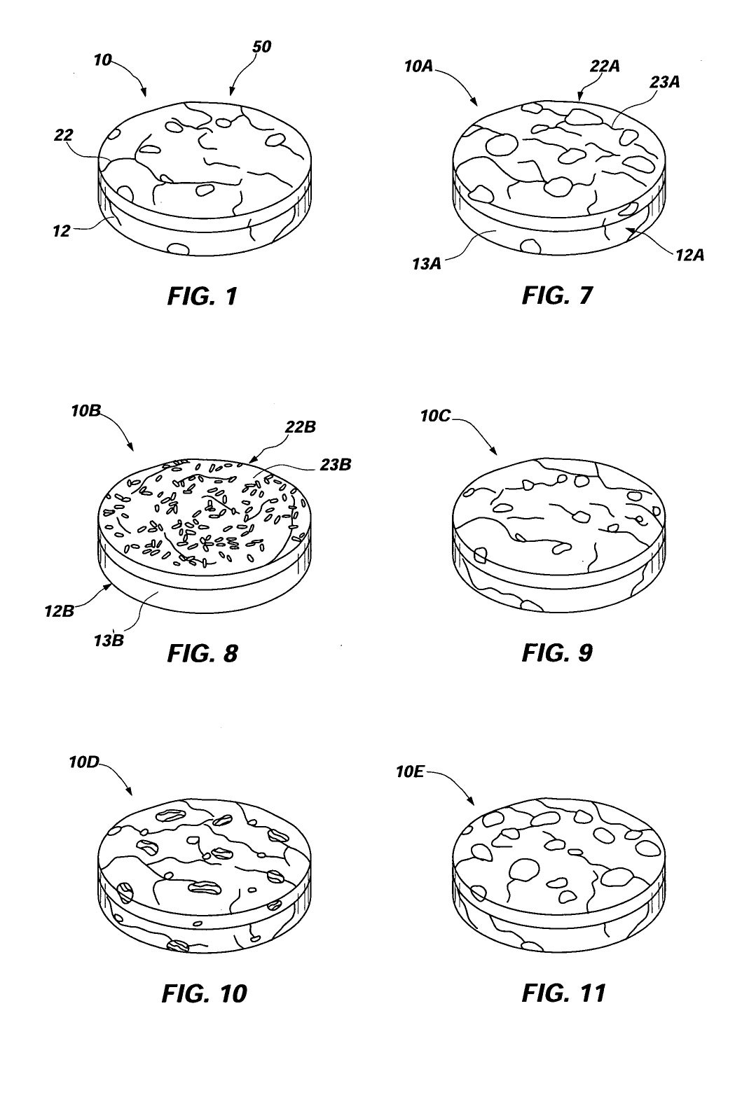

With reference to FIG. 1, an exemplary container 10 that incorporates teachings of the present invention is shown. Container 10 includes a base 12 and a cover 22, which are configured to be assembled with and secured to one another. As shown in FIG. 4, cover 22 includes an exterior surface 23 which has a desired appearance, in this case, that of a cookie (e.g., the appearance of chocolate chip cookie, as depicted). An exterior surface 13 of base 12 may also be configured in such a way as to complete the desired appearance, as shown in FIG. 5.

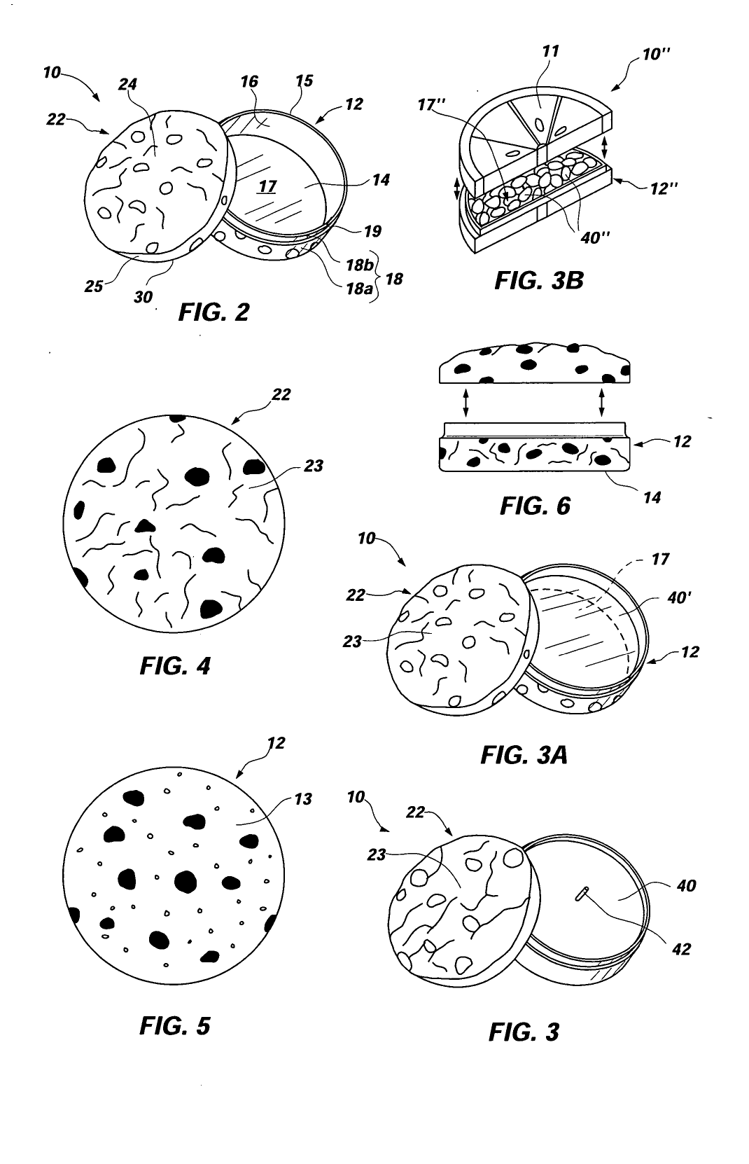

As shown in FIGS. 2 and 6, base 12 includes a bottom 14 and at least one side wall 15 protruding generally upwardly, but not necessarily perpendicularly, from bottom 14. A receptacle 17 is defined within an interior 16 of side wall 15, over bottom 14. In addition, a ledge 19 may be located on an exterior 18 of side wall 15, defining a boundary between a lower section 18a of exterior 18 and an upper section 18b of exterior 18, with lower section 18a having a larger lateral dimension (e.g., diameter, circumference, perimeter, etc.) than the corresponding dimension of upper section 18a. In the illustrated example, ledge 19 completely circumscribes exterior 18 of side wall 15. Ledge 19 is configured to provide a stop for a bottom edge 30 of cover 22 when cover 22 is assembled with base 12.

Cover 22 includes a top 24 and a side wall 25, at least a portion of which protrudes generally downwardly, but not necessarily perpendicularly or linearly, from top 24. An interior (not shown) of side wall 25, as well as an adjacent surface (not shown) of top 24, defines a receptacle (not shown), which is configured to receive at least the portion of base 12, including upper section 18b of exterior 18 of side wall 15, located above ledge 19. A lip (not shown), which may be configured to provide an interference or pressure fit against upper section 18b and, thus to removably secure cover 22 to base 12, protrudes somewhat inwardly from the interior of side wall 25 and may be located at or adjacent to edge 30 of side wall 25.

In FIG. 3, a candle 40 is shown as being disposed within receptacle 17 of base 12. Candle 40 may be scented to have the fragrance, or aroma, that corresponds to that of the type of cookie, other baked good, or other item (e.g., fruit, pizza, hamburger, etc.) represented by exterior surface 23 of at least cover 22. Candle 40 may also have an appearance which is similar to that of cover 22. Continuing with the example of a container 10 which resembles a chocolate chip cookie, candle 40 may have the aroma of a freshly baked chocolate chip cookie.

Alternatively, as illustrated in FIG. 3A, receptacle 17 of base 12 of container 10 may be filled with other contents 40′ that have a fragrance or flavor that corresponds to the item represented by exterior surface 23 of at least cover 22. Examples of such contents 40′ include, but are not limited to, air fresheners, creams, balms, bath salts, and the like.

In another example, shown in FIG. 3B, an exemplary container 10″ has an exterior 11 with the appearance of a lemon slice and includes a receptacle 17″ of a base 12″ thereof which is at least partially filled with lemon drop candies 40″. Of course, containers with other appearances that are filled with correspondingly flavored candies or other edible items are also within the scope of the present invention.

Although FIGS. 1 through 6 depict a container 10 having the appearance of a chocolate chip cookie, containers that appear as other types of cookies are also within the scope of the present invention. Examples of such containers 10A-10E are shown in FIGS. 7 through 11, respectively. In FIG. 7, the exteriors 23A and 13A of cover 22A and base 12A of container 10A resemble a white chunk macadamia cookie. FIG. 8 shows a container 10B which includes a cover 22B and base 12B with exteriors 23B and 12B that are configured to look like a pink-frosted sugar cookie. A container 10C which has the appearance of a fudge chocolate chip cookie is shown in FIG. 9, while FIGS. 10 and 11 respectively illustrate containers 10D and 10E that resemble an oatmeal raisin cookie and a cookie with chocolate chips and candy-coated chocolates, such as those sold by M&M/Mars of Hackettstown, N.J., as M&M's® candies.

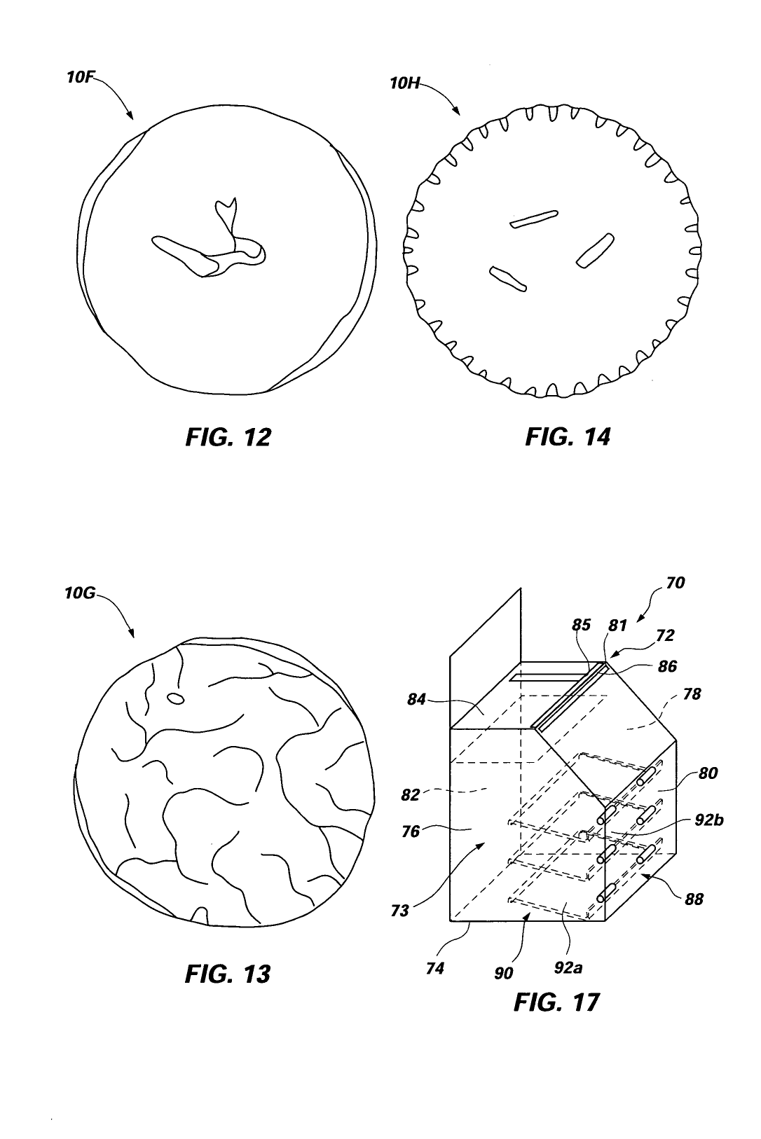

Turning now to FIGS. 12 through 14, other exemplary configurations of containers that resemble bakery goods and that incorporate teachings of the present invention are illustrated. FIG. 12 depicts a container 10F that has the appearance of a doughnut. FIG. 13 shows a container 10G that looks like a muffin. The container 10H illustrated in FIG. 14 has the appearance of a pie.

Processes for manufacturing containers that incorporate teachings of the present invention depend, of course, upon the materials from which such containers are to be formed. By way of example only, and with returned reference to FIG. 6, when a container 10 according to the present invention comprises a so-called “tin” and is formed from a metal, known die cutting, stamping, and embossing processes may be used to form both base 12 and cover 22 thereof from one or more sheets of metal. Of course, these techniques may be effected as known in the art, such as with suitable cutting presses and dies, stamping presses and forms, and/or embossing presses and forms. The embossing or stamping equipment may at least partially impart exteriors 13 and 23 of base 12 and cover 22, respectively, with the desired dimensions (e.g., dimensions that are substantially the same as, smaller than, or larger than those of the represented item) and appearance (e.g., of a cookie or other bakery good, a piece of fruit or a section thereof, etc.). Of course, other processes, which are suitable for use with other types of materials, may also be used to form a container (e.g., container 10) according to the present invention. For example, glass containers may be shaped from molten glass, as known in art, while ceramic containers may be formed to have the desired shape, glazed, and baked, or “fired,” as known in the art. Plastic containers may be formed from a variety of suitable molding processes, including, without limitation, injection molding, transfer molding, and blow molding.

Returning reference to FIGS. 1 through 6, the desired appearance of a container (e.g., container 10) of the present invention may be further enhanced by printing, painting, or otherwise applying (e.g., in the form of a preprinted decal) a graphical representation 50 of the represented item (e.g., a cookie or other baked good, a piece of fruit or section thereof, etc.) on an exterior 23, 13 of cover 22 or base 12. Each of these processes may be effected in a manner known in the art. Depending again upon the material or materials from which the container is formed, these appearance-enhancement processes may be effected before the cover or base is formed, during manufacture of the cover or base, or following fabrication of the cover or base.

Once the container (e.g., container 10) has been manufactured, one or more contents (e.g., candle 40, contents 40′, candies 40″, etc.) that have a fragrance or a flavor that simulates the fragrance or flavor of the item represented by the exterior of the container may be introduced into receptacle 17 of the base 12 thereof. Thereafter, cover 22 may be assembled with and secured to base 12.

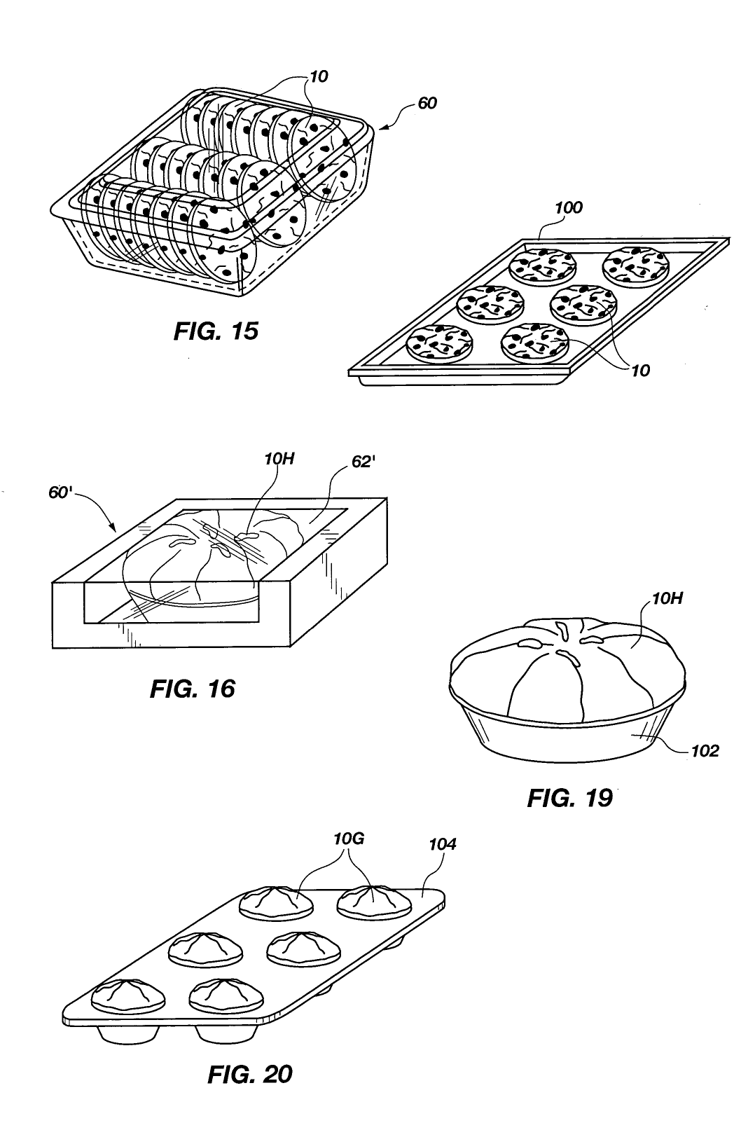

Turning now to FIGS. 15 through 21, various examples of packages and display apparatus for containers that incorporate teachings of the present invention are illustrated, as are the packaged and displayed containers, which are also within the scope of the present invention.

In FIG. 15, a transparent bakery box 60, or package, which may be formed from a plastic material, such as polyethylene terephthalate (PETE or PET), is shown. Transparent bakery box 60 is configured to hold and store a plurality of containers of the present invention. As illustrated, transparent bakery box 60 contains a dozen containers 10 that look like cookies, although bakery boxes that are configured to hold fewer containers (e.g., one, two, six, etc.) or more containers (e.g., 18, 24, 36, etc.) are also within the scope of the present invention. Such transparent bakery boxes 60 may have standard configurations (e.g., be ready-to-hold cookies having dimensions within a particular range) or nonstandard configurations (i.e., larger or smaller than normal). They are readily available from a variety of sources. Also within the scope of the present invention are transparent bakery boxes that are similar to transparent bakery box 60, but which are configured to hold or store other types of bakery goods and, thus, are configured to hold or store containers of the present invention that are representative of different types of bakery goods (i.e., other than cookies).

FIG. 16 illustrates a cardboard bakery box 60′, or package, within which a single container 10H that resembles a pie may be enclosed or within which multiple containers, such as those that resemble cookies (e.g., containers 10, 10A through 10E), doughnuts (e.g., container 10F), or muffins (e.g., container 10G), may be enclosed. Cardboard bakery box 60′ may include a window 62′, through which a portion of a container therein may be viewed. Like transparent bakery box 60, cardboard bakery box 60′ may have either standard or nonstandard dimensions and is commercially available from a wide variety of sources.

An example of a display rack 70 that includes one or more containers (e.g., the illustrated container 10) of the present invention in accordance with teachings of the present invention is shown in FIG. 17. As illustrated, display rack 70 may be configured as a conventional bakery display rack, or even comprise a conventional bakery display rack. By way of example only, display rack 70 may include an enclosure 72 with a base 74, sides 76, 78, a front 80, a back 82, and a top 84, some or all of which may be transparent or include a transparent section so that the contents of display rack 70 may be viewed from the exterior thereof. Front 80 of display rack 70 may include or comprise a door, which is configured to be opened and closed, as known in the art (e.g., by hinges, sliding, or otherwise). In the illustrated example, an upper edge 81 of front 80 is secured to a front edge 85 of top 84 with a hinge 86. A handle 88 is included on front 80 to facilitate opening of enclosure 72 by an individual. Shelving 90, including a plurality of shelves 92a, 92b, etc., are positioned within an interior 73 of enclosure. Shelves 92a, 92b, etc. may be freestanding and, thus supported by base 74, or permanently or temporarily secured in place relative to sides 76, 78, base 74, top 84, or back 82 by any suitable means known in the art (e.g., adhesively, by resting upon pins that protrude laterally from sides 76, 78 or back 82, etc.).

Other examples of apparatus for presenting containers that incorporate teachings of the present invention include, but are not limited to, the cookie sheet 100 shown in FIG. 18, by which a plurality of containers 10 are carried, the pie tin 102 depicted in FIG. 19, within which a container 10H that resembles a pie may be presented, and the muffin tin 104 shown in FIG. 20, which includes a plurality of receptacles, as known in the art, for carrying containers 10G that look like muffins.

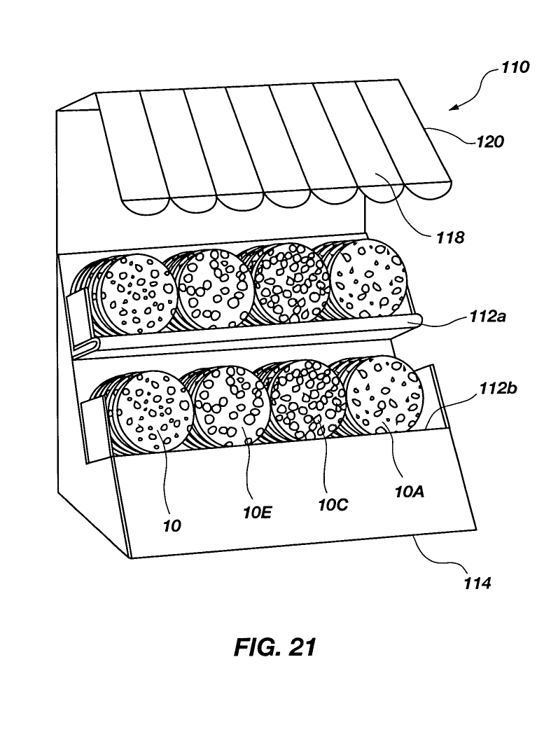

Another example of display apparatus 110 is shown in FIG. 21. Display apparatus 110 may be formed from a variety of materials, including cardboards (e.g., a sheet of corrugated cardboard which has been printed on, cut and folded, as known in the art) and plastics (e.g., sheets of plastic that have been cut and bent or otherwise formed to desired dimensions and shapes, printed on or painted, and secured to one another, as known in the art), and may include a plurality of shelves 112a, 112b upon which containers (e.g., containers 10, 10E, 10C, 10A) may be displayed. Display apparatus 110 may have a configuration and dimensions which facilitate placement thereof upon a countertop or shelf in a store, with a base 114 thereof resting upon the countertop, shelf, or other surface. As shown, display apparatus 110 also includes an overhang 118 extending downwardly from a top 116 thereof, over shelves 112a, 112b. Overhang 118 carries indicia 120, which may, as illustrated, represent a source of or a trademark representative of the containers that are presented by display apparatus 110.

With reference again to FIGS. 1 through 6, an example of use of a container 10 of the present invention is described. When access to the contents of container 10 is desired, cover 22 thereof may be removed. The content or contents of container 10, such as the depicted candle 40 held within receptacle 17 of base 12, is then accessible. A wick 42 of candle 40 may then be lit (e.g., with a match, a lighter, etc.), causing the fragrance of candle 40 to permeate the air surrounding candle 40, as known in the art. Once use of candle 40 or access to other contents within receptacle 17 of base 12 is no longer desired, cover 22 may be disposed over, assembled with, and secured to base 12 to store the contents thereof until access thereto is again desired. As known in the art, when cover 22 is disposed over a lit candle 40, the lack of oxygen within the closed container 10 will eventually “smother” the flame.

When the contents of container 10 have been used, receptacle 17 of base 12 of container 10 may be cleaned and new contents may be introduced into receptacle 17. The newly introduced contents may or may not have a fragrance or flavor that corresponds to external appearance of container 10.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

1. A container, comprising:
a base within which a receptacle is defined;
a cover configured to be disposed over the base, the cover including:
a receptacle configured to receive and removably retain at least an upper edge of the base; and
an exterior having the appearance of a bakery good.

2. The container of claim 1, wherein the base also includes an exterior having the appearance of the bakery good.

3. The container of claim 1, wherein the bakery good comprises at least a piece of one of a cookie, a muffin, a doughnut, a bagel, a pie, and a cake.

4. The container of claim 1, further comprising:
contents within the receptacle of the base, the contents having at least one of a fragrance and a flavor that corresponds to the represented bakery good.

5. The container of claim 4, wherein the contents comprise a candle.

6. The container of claim 5, wherein at least a portion of the candle also has the appearance of the bakery good.

7. The container of claim 4, wherein the contents comprise one of an air freshening composition, at least one piece of candy, a cream, a balm, a wax, a gel, a plurality of water-absorbent particles or beads, a bath salt, and a liquid.

8. The container of claim 1, wherein the base and the cover comprise metal.

9. A container, comprising:
a base comprising metal and including a receptacle;
a cover comprising metal and configured to be disposed over the base, the cover including:
a receptacle configured to receive and removably retain at least an upper edge of the base; and
an exterior having the appearance of an item with a fragrance or a flavor; and
contents within the receptacle of the base, the contents having at least one of a fragrance and a flavor that represents that of the item represented by the exterior of the cover.

10. The container of claim 9, wherein the base also includes an exterior having the appearance of the item.

11. The container of claim 9, wherein the item comprises a fruit.

12. The container of claim 9, wherein the item comprises a bakery good.

13. The container of claim 9, wherein the contents comprise at least one piece of candy.

14. The container of claim 9, wherein the contents comprise a candle.

15. The container of claim 14, wherein at least a portion of the candle also has the appearance of the item.

16. The container of claim 9, wherein the contents comprise one of an air freshening composition, a cream, a balm, a wax, a gel, a plurality of water-absorbent particles or beads, a bath salt, and a liquid.

17. A method for using a container including an exterior that appears as another item, comprising:
removing a cover of the container from a base of the container to expose contents of a receptacle of the base, the contents having at least one of a fragrance and a flavor that represents the fragrance or flavor of the item represented by the exterior of the container; and
accessing the contents to sense at least one of the fragrance and flavor thereof.

18. The method of claim 17, further comprising:
replacing the cover on the base so as to removably secure the cover to the base.

19. The method of claim 17, further comprising:
cleaning the receptacle of the base when the contents have been substantially removed therefrom; and
introducing other contents into the receptacle of the base.

20. A method for manufacturing a container, comprising:
forming a base that includes a receptacle;
forming a cover to be assembled with and secured to the base;
providing at least the cover with an external appearance of an item having at least one of a fragrance and a flavor;
introducing at least one content into the receptacle of the base, the at least one content having at least one of a fragrance and a flavor that simulates the fragrance or flavor of the item represented by the external appearance; and
assembling the cover with the base.
